(19) United States
(12) Patent Application Publication
(10) Pub. No.: US 2014/0344376 A1
(43) Pub. Date: Nov. 20, 2014

(54) PUBLICATION OF TEXT MESSAGE CONVERSATIONS ON A SOCIAL NETWORKING PLATFORM

(71) Applicant: Tawkers, Inc., New York, NY (US)

(72) Inventors: Blake Ian Goldsmith, New York, NY (US); Jordan Sudy, New York, NY (US); Rodrigo Bartels Gonzalez, Heredia (CR)

(73) Assignee: Tawkers, Inc., New York, NY (US)

(21) Appl. No.: 14/270,928

(22) Filed: May 6, 2014

Related U.S. Application Data
(63) Continuation of application No. 13/896,997, filed on May 17, 2013.

(51) Int. Cl. G06Q 50/00

(52) U.S. Cl. CPC G06Q 50/01
USPC 709/206

(57) ABSTRACT

Various embodiments relate to a method and related device and storage medium encoded with instructions including: establishing a text messaging conversation between a local and remote user, wherein the conversation is initially an unpublished conversation; enabling communication between the local and remote user via the conversation; receiving a command to publish the conversation; in response, transmitting a request to publish at least a portion of the conversation to a server that provides additional users access to published conversations. Various embodiments relate to a method and related device and storage medium encoded with instructions including receiving a request to publish at least a portion of an unpublished conversation between a first and second user; creating a published conversation object in response, wherein the object identifies messages between the first and second user from the conversation; and serving data representing the messages to additional users.

This application is a continuation-in-part of U.S. patent application Ser. No. 13/896,997, filed on May 17, 2013, which claims the benefit of U.S. provisional patent application No. 61/648,785, filed on May 18, 2012, the entire disclosures of which are hereby incorporated herein by reference for all purposes.

### TECHNICAL FIELD

Various exemplary embodiments disclosed herein relate generally to online communication and, more particularly but not exclusively, to publication of user conversations on a social networking platform.

### BACKGROUND

Computer networks such as the Internet provide high speed mass communication. Social networking uses the Internet to communicate among various groups. Online communication through social networks is frequently unorganized and chaotic, preventing the medium from fulfilling its potential. Accordingly, there is need for a new social networking platform.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments relate to a non-transitory machine-readable storage medium encoded with instructions for execution by a user device, the non-transitory machine-readable storage medium comprising: instructions for establishing a new text messaging conversation between a local user and a remote user, wherein the new text messaging conversation is initially an unpublished conversation that is accessible to only the local user and the remote user; instructions for enabling continued communication between the local user and the remote user via the text messaging conversation; instructions for receiving, from the local user, a command to publish the text messaging conversation; instructions for, in response to receiving the command to publish the text messaging conversation, transmitting a publish request to publish at least a portion of the text messaging conversation to a social networking server that provides additional users access to published conversations. Various embodiments relate to a related method performed by executing such instructions and user device configured to perform the functions achieved by such instructions.

Various embodiments are described wherein the instructions for establishing, enabling, receiving, and transmitting are part of a single application, the non-transitory machine-readable storage medium further comprising: instructions for presenting a contact list to the local user, wherein the contact list includes both social network contacts that are associated with the social networking server and external contacts that are associated with a communication channel other than the social networking server; and instructions for presenting a visual distinction between the social network contacts and the external contacts.

Various embodiments are described wherein: the instructions for establishing and the instructions for enabling are part of a first application, the instructions for receiving and the instructions for transmitting are part of a second application that is different from the first application, and the publish request comprises an import request to import the text messaging conversation to the social networking server from an external service associated with the first application.

Various embodiments are described wherein the publish message includes data representing a plurality of text messages from the text messaging conversation.

Various embodiments are described wherein the publish message identifies an external service that implements an application programming interface (API) configured to provide the social networking server with data representing a plurality of text messages from the text messaging conversation.

Various embodiments additionally include instructions for displaying a plurality of comments from the additional users in association with the text messaging conversation.

Various embodiments relate to a non-transitory machine-readable storage medium encoded with instructions for execution by a social networking server, the non-transitory machine-readable storage medium comprising: instructions for receiving, from a user device, a publish request to publish at least a portion of an unpublished text messaging conversation between a first user and a second user; instructions for creating a published conversation object in response to receiving the publish request, wherein the published conversation object identifies a plurality of text messages between the first user and the second user from the at least a portion of the text messaging conversation; and instructions for serving data representing the plurality of text messages to a plurality of additional users based on the published conversation object. Various embodiments relate to a related method performed by execution of such instructions.

Various embodiments relate to asocial networking server comprising: a network interface in communication with a plurality of user devices; a storage device configured to store a plurality of published conversation objects; and a processor in communication with the network interface and the storage device, the processor being configured to: receive, via the network interface from a first user device of the plurality of user devices, a publish request to publish at least a portion of an unpublished text messaging conversation between a first user and a second user, create a published conversation object for storage in the storage device in response to receiving the publish request, wherein the published conversation object identifies a plurality of text messages between the first user and the second user from the at least a portion of the text messaging conversation, and serve data representing the plurality of text messages to a plurality of additional users based on the published conversation object

Various embodiments additionally include instructions for receiving a plurality of comment messages regarding the plurality of text messages from the additional users; instructions for adding, to the published conversation object, identifications of the plurality of comment messages; and instructions for serving data representing the plurality of comment messages to the plurality of additional users in association with the data representing the plurality of text messages.

Various embodiments additionally include instructions for copying identifications of the plurality of text messages from a previously-created unpublished conversation object associated with the text messaging conversation to the published conversation object.

Various embodiments are described wherein the instructions for creating a published conversation object comprise: instructions for locating a previously-created unpublished conversation object associated with the text messaging conversation; and instructions for setting a value of the unpublished conversation object to indicate publication of the at least a portion of the unpublished text messaging conversation to convert the unpublished conversation object into the published conversation object.

Various embodiments are described wherein the instructions for creating a published conversation object comprise instructions for retrieving the plurality of text messages from the publish request.

Various embodiments are described wherein the instructions for retrieving the plurality of text messages from the publish request comprise instructions for parsing the plurality of text messages from raw data carried by the publish request.

Various embodiments are described wherein the instructions for creating a published conversation object comprise instructions for retrieving the plurality of text messages from an external server associated with an external service via an application programming interface (API).

### BRIEF DESCRIPTION OF THE DRAWINGS

In order to better understand various exemplary embodiments, reference is made to the accompanying drawings, wherein:

FIG. 1 illustrates an exemplary user interface for presenting a social networking platform;

FIG. 1A illustrates another exemplary user interface for presenting a social networking platform;

FIG. 2 illustrates another exemplary user interface for presenting a browser within a social networking platform;

FIG. 3 illustrates another exemplary user interface for presenting audience information within a social networking platform;

FIG. 4 illustrates another exemplary user interface for presenting notifications within a social networking platform;

FIG. 5 illustrates a user interface for generating a new event;

FIG. 6 illustrates an exemplary user interface for navigating between a plurality of events;

FIG. 7 illustrates another exemplary user interface for presenting statistics within a social networking platform;

FIG. 8 illustrates a flowchart showing various stages of an audience comment;

FIG. 9 illustrates an exemplary network for implementing a social networking platform;

FIG. 10 illustrates an exemplary user interface for presenting a contact list;

FIG. 11 illustrates an exemplary user interface for beginning a new conversation with a selected contact;

FIG. 12 illustrates an exemplary interface for presenting an unpublished conversation;

FIG. 13 illustrates an exemplary interface for publishing a conversation;

FIG. 14 illustrates an exemplary interface for presenting a list of unpublished conversations;

FIG. 15 illustrates an exemplary interface for presenting a list of published conversations;

FIG. 16 illustrates an exemplary method for establishing a new conversation;

FIG. 17 illustrates an exemplary method for publishing a previously-created conversation;

FIG. 18 illustrates an exemplary method for importing a conversation using raw data;

FIG. 19 illustrates an exemplary method for importing a conversation via an external server application programming interface (API);

FIG. 20 illustrates an exemplary data arrangement for storing a published conversation;

FIG. 21 illustrates an exemplary data arrangement for storing an unpublished conversation; and

FIG. 22 illustrates exemplary hardware for implementing a user device or a server.

### DETAILED DESCRIPTION

Referring now to the drawings, in which like numerals refer to like components or steps, there are disclosed broad aspects of various exemplary embodiments.

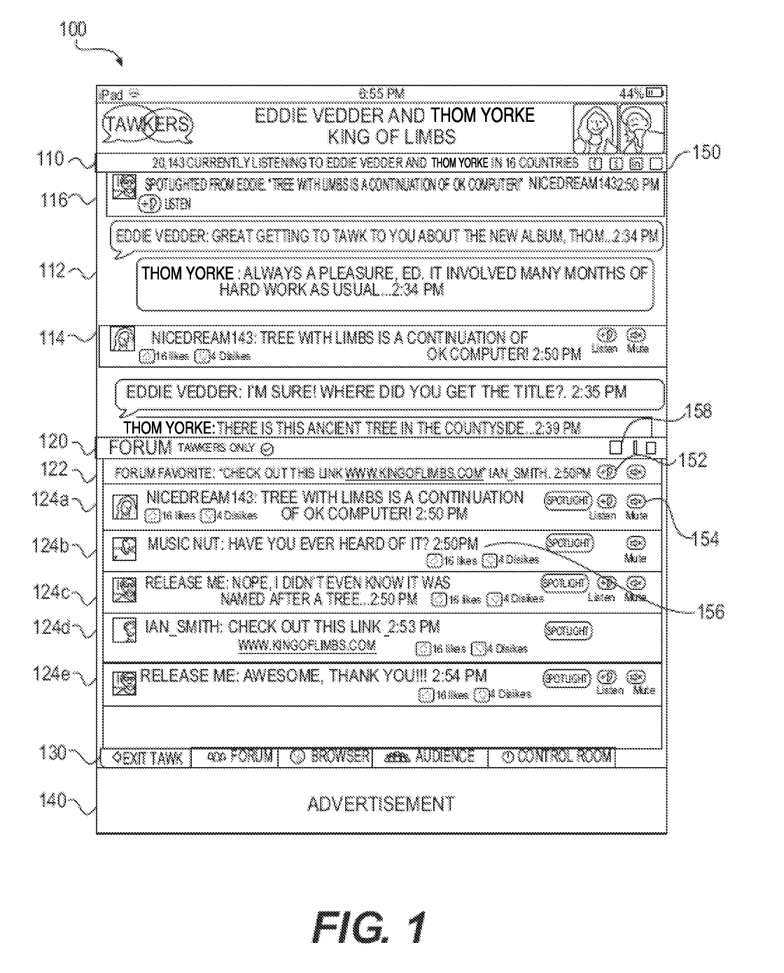

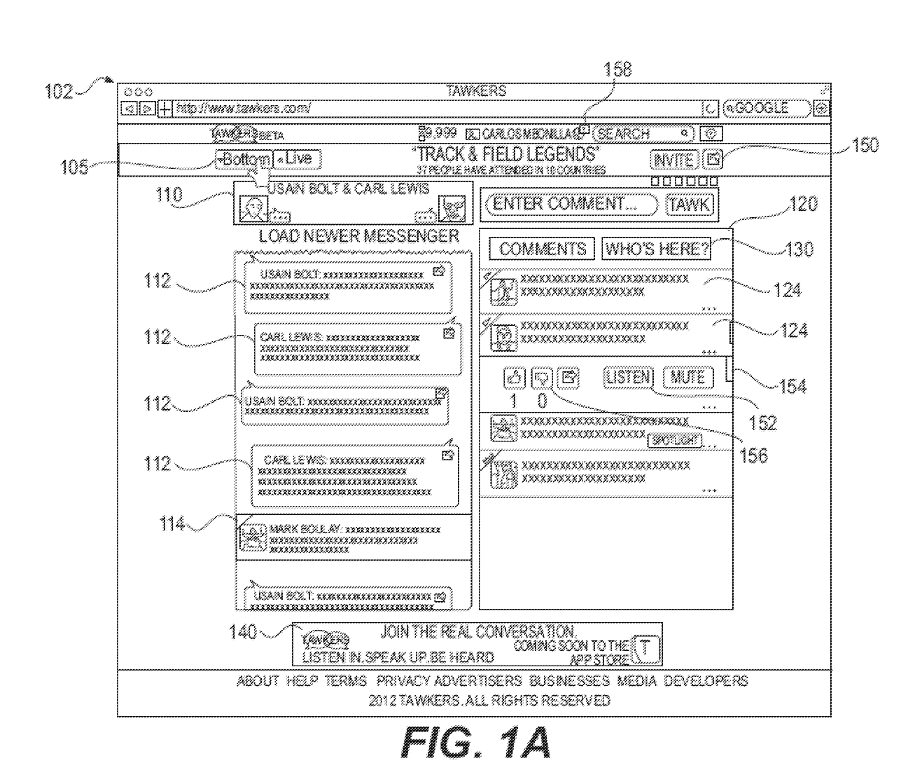

FIG. 1 illustrates an exemplary user interface 100 for presenting a social networking platform. The exemplary user interface 100 may include a host panel 110, lower panel 120, selection panel 130, content panel 140. Exemplary user interface 100 may also include various interaction buttons including: sharing buttons 150, listen button 152, mute button 154, rating buttons 156, and notifications button 158.

Host panel 110 may present content from two or more event hosts and information about the event. For example, host panel 110 may indicate the names of the host, a name of the event, an audience size, and an audience location. Host panel 110 may also include host comments 112, spotlighted comment 114, and most recently spotlighted comment 116. The host panel 110 may have a prominent location within the user interface. For example, host panel 110 may be located on the top half of the interface 100. The host panel may be under the control of the hosts, allowing the online event to focus on the content provided by the hosts.

Host comments 112 may be comments made by event hosts as part of the event. The host comments 112 may be visible to any audience member for the event. Host comments 112 may indicate the host who made the comment. Host comments 112 may be presented in the order made by the hosts and include a timestamp indicating when the comment was made.

Spotlighted comment 114 may be a comment made by an audience member that has been selected by an event host. For example, spotlighted comment 114 may correspond to forum comment 124a. When an event host selects a comment, the selected comment may appear in host panel 110. Spotlighted comment 114 may indicate the name of the audience member who made the comment as well as a timestamp the comment was made and the name of the host who selected the comment. Spotlighted comment 114 may also include interaction buttons, which will be discussed in further detail below.

Most recent spotlighted comment 116 may indicate a comment that has most recently been selected by a host. For example, most recent spotlighted comment 115 may correspond to spotlighted comment 114. Most recent spotlighted comment 116 may be located at a fixed location within host panel 110 such as, for example, the top. Most recent spotlighted comment 116 may remain visible even if spotlighted comment 114 is no longer displayed because, for example, host panel 110 has scrolled.

Lower panel 120 may be a forum panel, which may present content from audience members for an event. Forum panel 120 may include forum favorite 122 and audience comments 124. Forum panel 120 may be audience-moderated. That is, the comments displayed in forum panel 120 may be selected based on feedback from audience members. The comments may be displayed at a rate allowing audience members to read each comment. A method of audience moderating for the forum panel 120 will be discussed in further detail below.

Forum favorite 122 may indicate an audience comment that has received the highest rating from members of the audience. For example, forum favorite 122 may correspond to audience comment 124d. The selection of the forum favorite 122 may be based on the number of audience members who have positively rated the comment. Other factors such as negative ratings by audience members and a rating of the commenting audience member may also be considered.

Audience comments 124 may indicate comments made by audience members. For example, exemplary forum panel 120 displays audience comments 124a-e. Each audience comment 124 may be selected according to an audience moderation method. Audience comments 124 may also be presented based on selections made the user viewing user interface 100. For example, a user may indicate that the user always wants to view comments made by selected audience members or a user may indicate that the user never wants to view comments made by selected audience members.

Selection panel 130 may present various options for content to be located in the lower panel 120. Selection panel 130 may allow a user to select different content for lower panel 120 by selecting a button. Alternatively, second panel 130 may be swipable, allowing a user to change content by moving a finger or other indicator across lower panel 120. Selection panel 130 may indicate a lower panel 120 selected by swiping. Exemplary content panels that may be located in lower panel 120 include: a forum panel, a browser panel, an audience panel, and a control room panel. Selection panel 130 may also include an option for leaving the event.

Content panel 140 may provide a location for displaying additional content such as, for example, advertising. Content for content panel 140 may be provided by a service provider that hosts an event.

Sharing buttons 150 may be interaction buttons allowing a user to share information related to the event. Selecting of a sharing button 150 may generate a communication via an external communications channel or application.

Listen button 152 may be an interaction button allowing a user to view all comments made by a selected user. Listen button 152 may be associated with an audience comment. Selecting listen button 152 may add the audience member who posted the comment to a list of audience members whose comments are always displayed.

Mute button 154 may be an interaction button allowing a user to block all comments made by a selected user. Mute button 154 may be associated with an audience comment. Selecting mute button 154 may add the audience member who posted the comment to a list of audience members whose comments are never displayed.

Rating buttons 156 may allow a user to rate a comment made by another audience member. Rating buttons 156 may provide a first button for positively rating the comment and a second button for negatively rating the comment. Ratings provided by users selecting rating buttons 156 may affect a rating of the individual comment and the rating of the audience member. The rating of the individual comment and the rating of the audience member may, in turn, but used to determine whether audience comments 124 are displayed in forum panel 120.

Notifications button 158 may allow a user to view various notifications. Notifications button 158 may indicate a number of notifications available for viewing. As shown in FIG. 1, the notification button 158 may be located at the top of forum panel 120. In various alternative embodiments, the notifications button 158 may be located on selection panel 130.

FIG. 1A illustrates another exemplary user interface 102 for presenting a social networking platform. User interface 102 may be similar to user interface 100, but may be formatted for display as a web application within a browser. User interface 102 may use a side-by-side arrangement of host panel 110 and audience forum panel 120. User interface 102 may include control buttons 105 for moving between desired portions of the event in the host panel 110. Various buttons on user interface 100 may be presented as menus. For example, notifications button 158 and sharing buttons 150 may be presented as a drop down list. Buttons related to individual audience member comments 124 may be hidden behind the comment itself. For example, clicking the comment 124 may reveal rating buttons 156, listen button 152, or mute button 154.

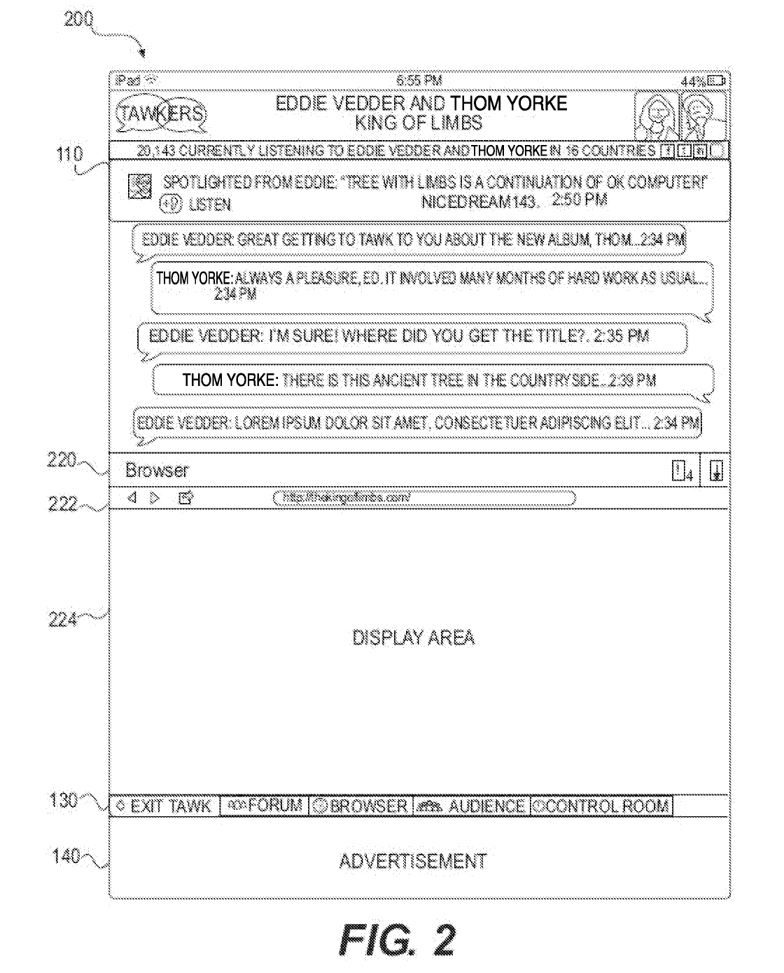

FIG. 2 illustrates another exemplary user interface 200 for presenting a browser within a social networking platform. User interface 200 may be similar to user interface 100. User interface 200 may be presented when a user selects a different lower panel 220. User interface 200 may include host panel 110, selection panel 130, and content panel 140, all of which may be similar to the corresponding panels described above regarding FIG. 1. User interface 200 may also include browser panel 220. A user may use browser panel 220 to view content related to an event without leaving the event. In particular, a user may be able to view content mentioned in a host comment 112 or an audience comment 124.

Browser panel 220 may present a browser for viewing content such as, for example, web pages and other documents. Browser panel 220 may include navigation options 222 and display area 224. Navigation options 222 may allow a user to select content to be viewed in display area 224. Display area 224 may display content selected by a user. Display area 224 may also allow a user to select content through known methods such as hyperlinks.

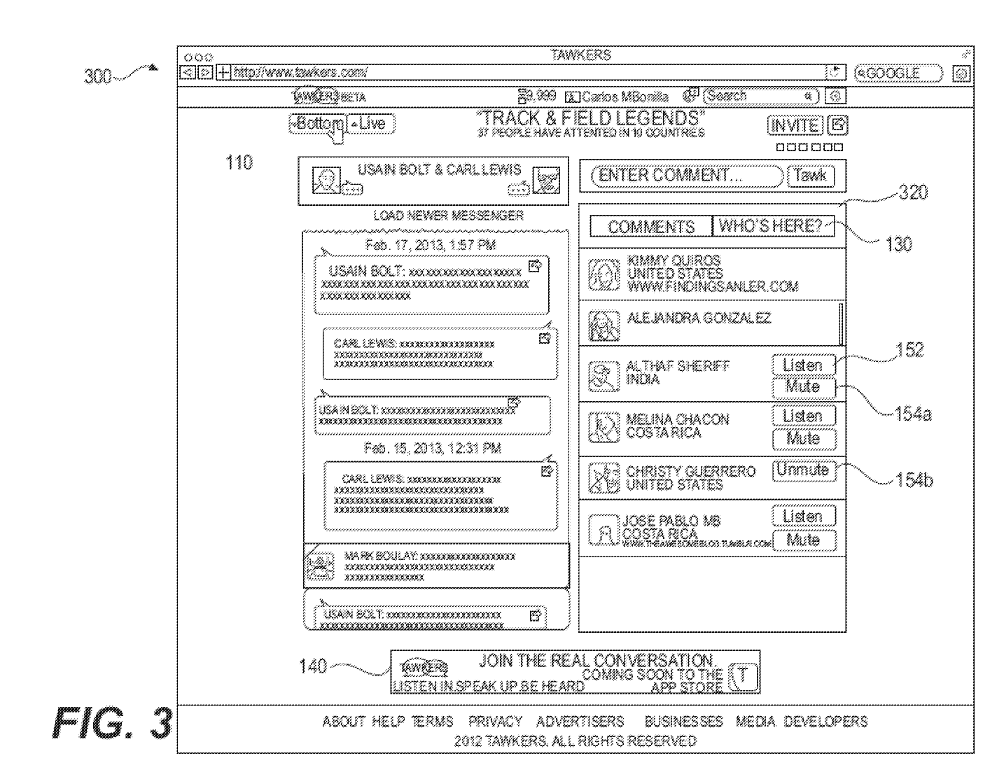

FIG. 3 illustrates another exemplary user interface 300 for presenting audience information within a social networking platform. User interface 300 may be similar to user interface 102. User interface 300 may be presented when a user selects a different audience panel 320. User interface 300 may include host panel 110, selection panel 130, and content panel 140, all of which may be similar to the corresponding panels described above regarding FIG. 1. User interface 300 may also include audience panel 320. A user may use audience panel 320 to view information regarding audience members of an event without leaving the event. In particular, a user may be able to view a complete list of audience members for the event. Audience panel 320 may be useful for locating audience members whose comments do not appear in forum panel 120, for example, muted audience members and low rated audience members.

Audience panel 320 may present a list of audience members viewing the event. Audience panel 320 may include one or more audience profiles 322. Audience profiles 322 may provide information regarding the audience member such as, for example, a picture, name, and location. Audience profiles 322 may be selectable and provide additional information when selected. Audience profiles 322 may also include a listen button 152 and a mute button 154. Listen button 152 and mute button 154 may be similar to like numbered buttons described above. Additionally, mute button 154 may indicate a status of the audience member. For example, mute button 154a may indicate that the audience member is not muted and mute button 154b may indicate that the audience member is muted and allow the user to unmute the audience member.

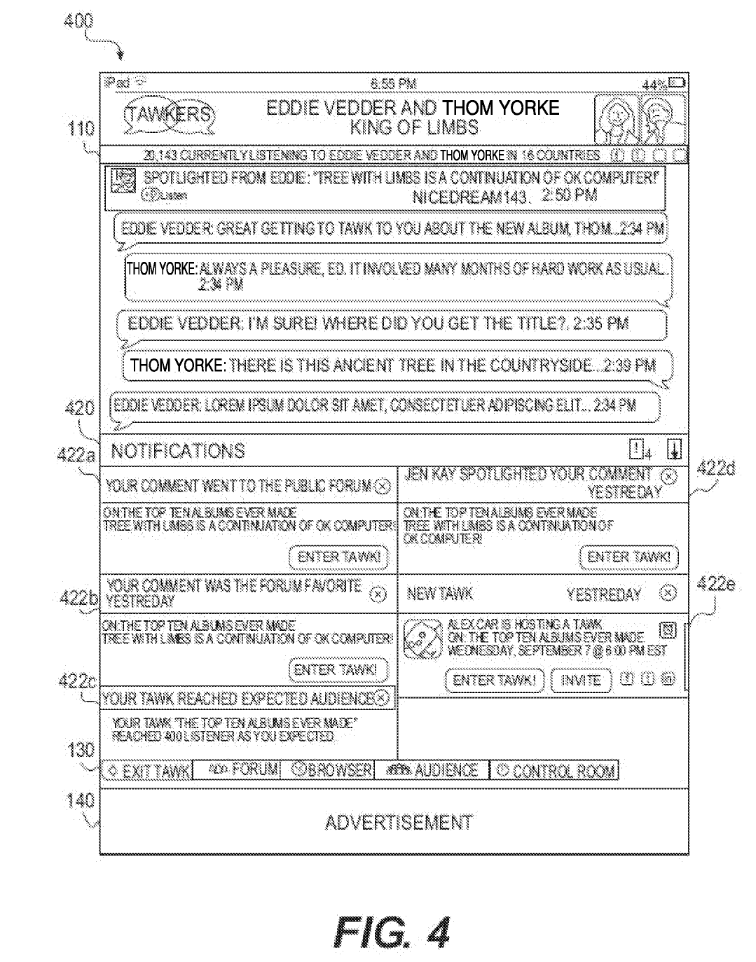

FIG. 4 illustrates another exemplary user interface 400 for presenting notifications within a social networking platform. User interface 400 may be similar to user interface 100. User interface 400 may be presented when a user selects notifications button 158. User interface 400 may include host panel 110, selection panel 130, and content panel 140, all of which may be similar to the corresponding panels described above regarding FIG. 1. User interface 400 may also include notifications panel 420. A user may use notifications panel 420 to view various notifications 422 provided by the social networking platform.

Notification 422a may indicate that a comment posted by the user has become viewable on the forum panel 120 for the event. Notification 422a may provide information about the comment including the event and content of the comment. Notification 422a may also provide a button enabling the user to enter the event where the comment is viewable.

Notification 422b may indicate that a comment posted by the user has become a forum favorite 122 for the event. Notification 422b may provide information about the comment including the event and content of the comment. Notification 422b may also provide a button enabling the user to enter the event where the comment is viewable.

Notification 422c may indicate that an event created by the user has obtained a certain status. For example, notification 422c may indicate that the event has reached a certain audience size. The user may be able to set a threshold measurement for an event and receive a notification when the event reaches the threshold measurement. Notification 422c may also provide a button enabling the user to enter the event.

Notification 422d may indicate that a comment posted by the user has been spotlighted by a host of the event. Notification 422d may provide information about the comment including the event, content of the comment, and name of the host who spotlighted the comment. Notification 422d may also provide a button enabling the user to enter the event where the comment is viewable.

Notification 422e may indicate that a new event has become available. Notification 422e may provide information regarding the event such as the name of the event and the name of the hosts of the event. Notification 422e may also provide a button to enter the event and sharing buttons 150 for communicating information regarding the event. Notification 422e may also be used to receive information regarding a particular host. For example, a user may opt to receive a notification whenever a certain host enters an event or creates a new event.

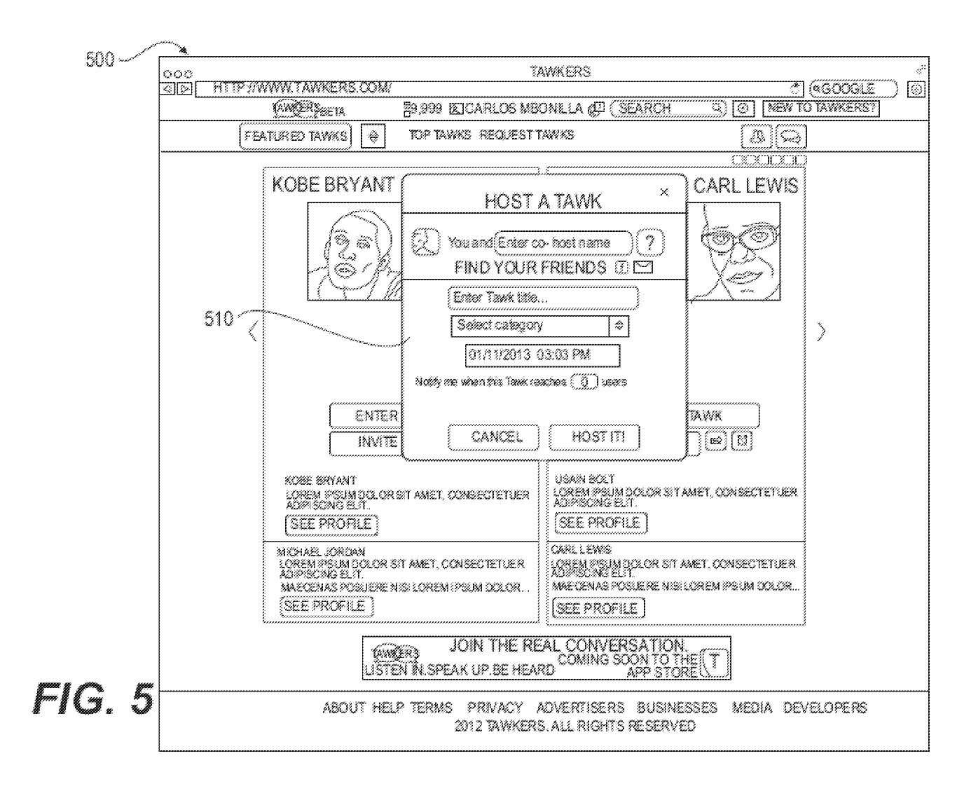

FIG. 5 illustrates a user interface 500 for generating a new event. User interface 500 may include box 510 for entering information regarding the event. Box 510 may include fields for various information for the event. For example, box 510 may include fields for: a title, a category, a date, a start time, a host biography, co-host names, and a notification threshold. Any user may use user interface 500 for creating a new event. When a user creates an event, the user may become a host of the event. Other users indicated in the co-host names field may also be hosts of the event. Events created using user interface 500 may be viewed by other users as audience members.

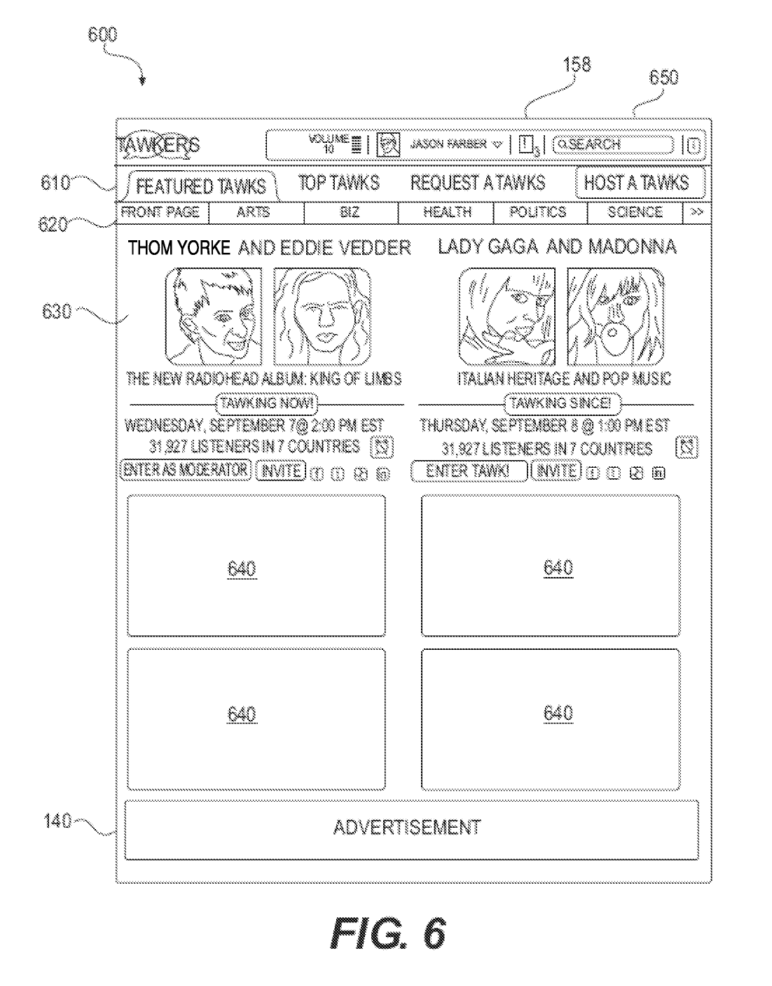

FIG. 6 illustrates an exemplary user interface 600 for navigating between a plurality of events. User interface 600 may include tabs 610, categories 620, event information 630, host profiles 640, and search box 650. User interface may also include a content panel 140 and notification button 158, described above with reference to FIG. 1.

Tabs 610 may provide a user with options for displaying information related to events. For example, tabs 610 may provide a featured events tab, a top events tab, and a request an event tab. The featured events tab may display events that have been selected by a service provider. The top events tab may display events that have the highest number of audience members. The request an event tab may provide a user an opportunity to request an event between certain hosts. A list of requested events may be displayed showing the most popular requested events.

Categories 620 may provide options for a user to select events based on the topic of the event. Selecting one of the categories 620 may provide event information 630 for events related to that category.

Event information 630 may provide information about an individual event. Event information 630 may include: the names of the hosts, the topic for the event, the current status of the event, the start time of the event, the number of audience members, and biographical information about the hosts. The event information 630 may also include buttons for entering the event as an audience member and buttons for sharing the event.

Host profiles 640 may include information regarding each host participating in the event. The host profile may include information available in audience member profile 322 and any additional information entered by the host for the particular event.

Search box 650 may allow a user to search for events. A user may enter keywords in search box 650 and be provided with a list of events related to the keywords.

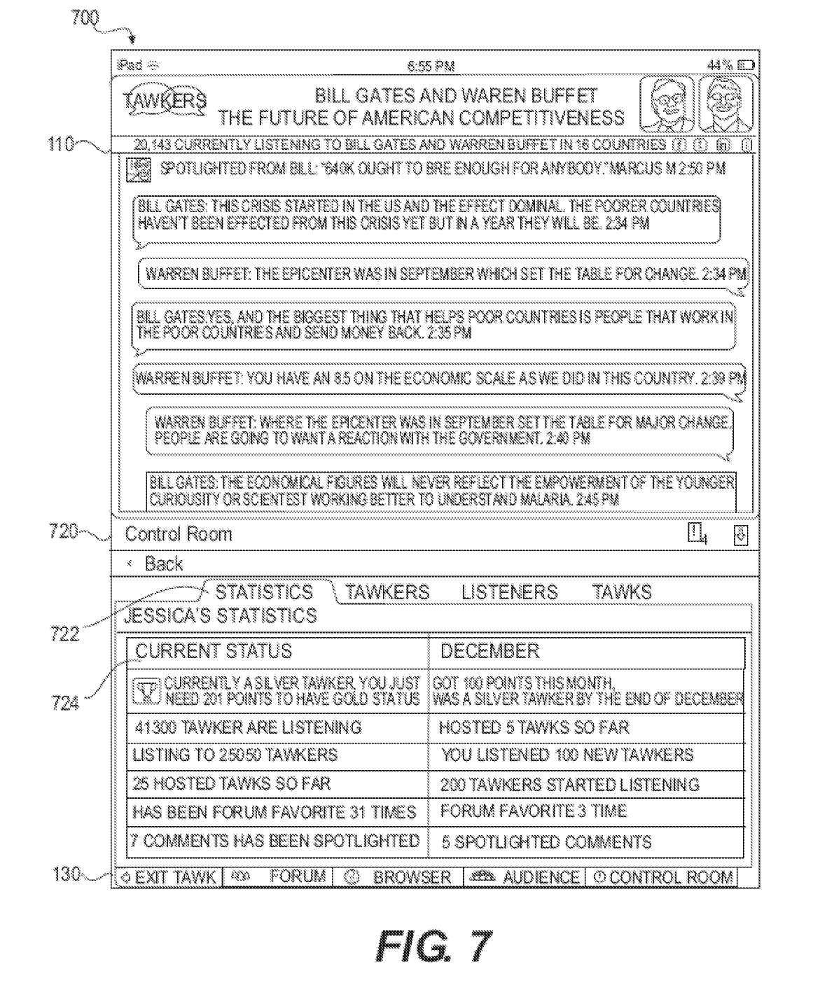

FIG. 7 illustrates another exemplary user interface 700 for presenting statistics within a social networking platform. User interface 700 may be similar to user interface 100. User interface 700 may be presented when a user selects a different lower panel 720. User interface 700 may include host panel 110, selection panel 130, and content panel 140, all of which may be similar to the corresponding panels described above regarding FIG. 1. User interface 700 may also include control room panel 720. A user may use control room panel 720 to view statistics regarding the user. In particular, a user may be able to view statistics contributing to the user's Volume as described below. Control room panel 720 may include tabs 722, and information area 724. Tabs 722 may allow options to view information regarding user statistics, selected users to listen to, users who are listening, and events. When a statistics tab is selected, the user may view information regarding the user's activity within the social networking platform. When a selected users tab is selected, information area 724 may present information regarding selected users who the user is listening to. When the listeners tab is selected, information area 724 may display information regarding other users who have chosen to listen to the current user. When the events tab is selected, the information area 724 may display information regarding past, current, and future events the current user has selected.

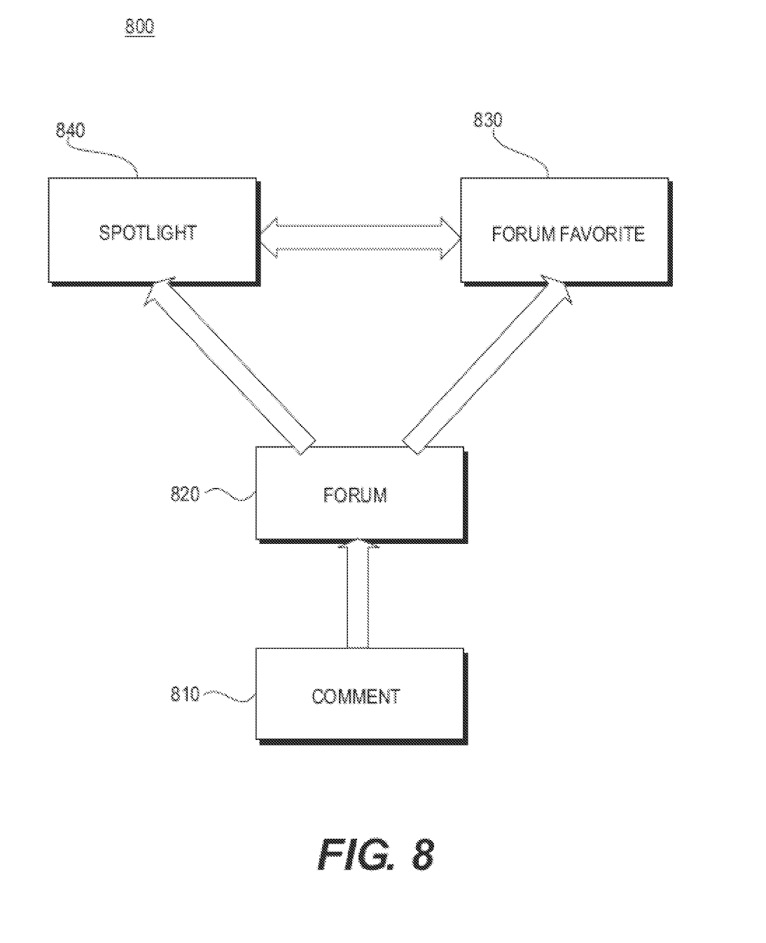

FIG. 8 illustrates a flowchart 800 showing various stages of an audience comment 124. In step 810, an audience member may post a comment to an event. The comment may be visible in the forum panel 120 by other audience members who have chosen to listen to the audience member posting the comment, for example, by selecting listen button 152. Those audience members who are able to view the comment may rate the comment using rating buttons 156. When other audience members rate the comment, the rating of both the comment and the commenter may change.

In step 820, the comment may reach the public forum. A comment may reach the public forum if the rating of the particular comment exceeds a certain threshold for the event or the rating of the commenter is sufficiently high. The ratings of the comment and commenter may be combined to determine whether the comment is visible in the public forum. It may be possible for a comment to go directly to step 620 if the rating of the commenter is sufficiently high. A commenter may receive a notification when a comment becomes viewable in the public forum. When a comment is visible in the public forum, any user, including hosts, may view the comment unless the commenter has been muted by the particular user. A comment that is viewable in the public forum may continue to be rated by users.

In step 830, a comment may be selected as the forum favorite 122. The comment with the most positive ratings may be selected as the forum favorite 122. In various alternative embodiments, negative ratings may also be considered when determining a forum favorite 122. A commenter may be informed when a comment becomes the forum favorite. The commenter's rating may also receive a bonus when a comment becomes a forum favorite 122. Accordingly, a commenter who posts the forum favorite 122 may be likely to have all comments visible in the public forum. A forum favorite 122 may be replaced whenever another comment becomes more highly rated.

In step 840, a comment may be spotlighted by a host and become a spotlighted comment 114. A host may spotlight any comment that is visible in the public forum. The spotlighted comment 114 may be visible in the host panel 110. The spotlighted comment 114 may also be visible as the most recent spotlighted comment 116 until a host spotlights another comment. When a comment is spotlighted by a host, the commenter may receive a notification. Spotlighting a comment may also provide a bonus to the rating of the comment and/or the commenter. The bonus may vary based on the number of users in the audience when the comment is spotlighted.

A commenter's rating, or Volume, may be an important factor in determining whether a comment is visible in the public forum. The Volume may be represented by a number and a level. The Volume number may be a score determined based on various statistics regarding the user's activity within the social networking platform. For example, the Volume number may be based on statistics including: the number of events attended, the number of events hosted, the number of other users who listen to the user, the number of comments spotlighted, the size of the audience when a comment was spotlighted, the number of comments that were forum favorite, the number of net positive ratings, and the number of comments visible in the public forum. The various statistics may be combined to reflect the popularity of the user. For example, the statistics may be combined using a weighted average to obtain the Volume number. The volume number may be calculated periodically, for example, once a day.

The Volume may have a relative level based on a percentile of the Volume number in comparison to other users. The Volume level may be determined for each event. Accordingly, a user may have a lower Volume level in a popular and crowded event, but have a greater Volume level in a less crowded event.

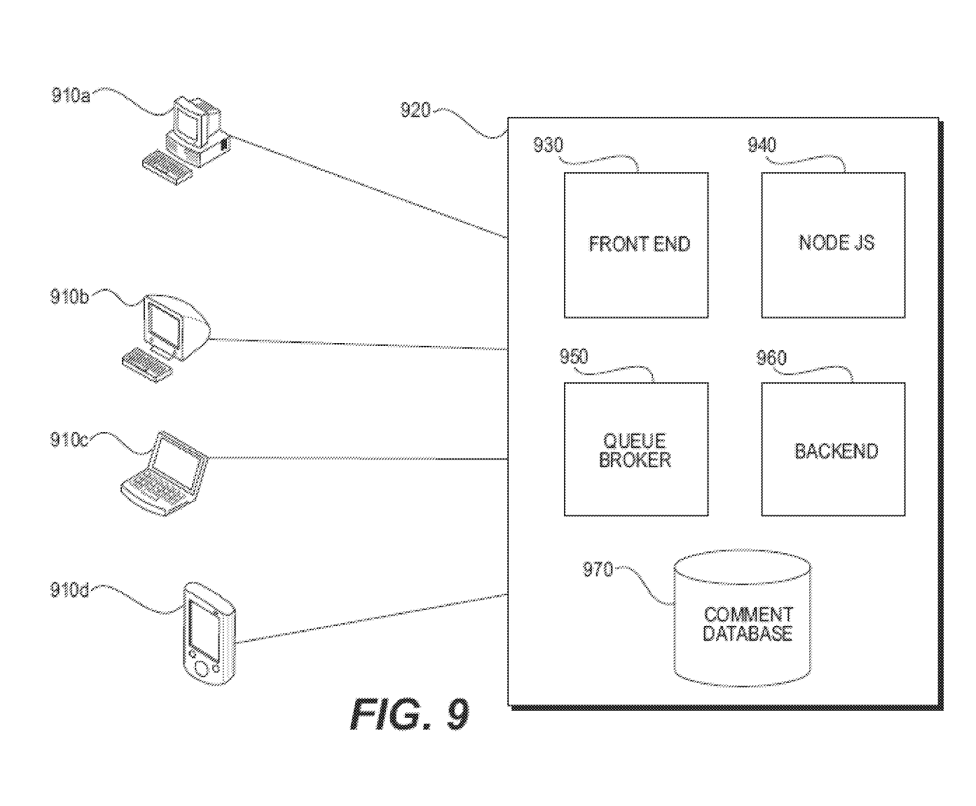

FIG. 9 illustrates an exemplary network 900 for implementing a social networking platform. Exemplary network 900 may include a plurality of user devices 910 in communication with a server 920.

User devices 910 may be any device capable of sending and receiving messages with server 920. User devices 910 may include personal computers, laptop computers, tablet computers, smart phones, personal digital assistants (PDA), and any other device capable of displaying a user interface and receiving input. In various embodiments, a user device 910 includes a browser application for displaying a website. The user device 910 may communicate with server 920 using the hypertext transfer protocol (HTTP). The browser may be a known browser application executing hypertext markup language (HTML) and/or javascript provided by server 920. In various embodiments, a user device 910 may run a customized application configured to display a user interface and receive input from a user. The application may also use HTTP or other known communication protocols.

Server 920 may be a web server configured to host a social network platform. Accordingly, server 920 may include a processor operably connected to a memory including instructions executable by the processor. In various embodiments, server 920 may be a cloud service. Accordingly, server 920 may be distributed across multiple physical servers, each having a processor and memory. Server 920 may include a front end module 930, a node JS module 940, a queue broker module 950, a backend module 960, and a comment database 970.

Front end module 930 may include computer software configured to present a user interface to a plurality of user devices 910. In various embodiments, front end module 930 may include HTML and javascript configured to present any of the user interfaces shown in FIGS. 1-7. The front end module 930 may serve the HTML and javascript to the user devices 910 when requested by a browser application.

Node JS module 940 may include computer software configured to manage connections between user devices 910 and server 920. Node JS module 940 may require each user of user devices 910 to login using a username and password. Upon login, Node JS module 940 may establish a websocket with the user device 910. The websocket may allow the Node JS 940 module to receive and push messages to the user devices 910. In various embodiments, the messages may be javascript object notation (JSON) messages following a JSON schema that may be understood by both server 920 and user devices 910. The JSON schema may define various types of messages used in the social network platform including comment messages, notifications, and user commands.

The queue broker 950 may include computer software configured to manage a plurality of message queues. The queue broker 950 may provide the contents of the queues to the node JS module 940 and the backend module 960. In various embodiments, queue broker 950 may include a queue for each user device 910, a host comment queue, and a user comment queue. The queue for each user device 910 may be a queue of messages to provide to the user device such as host comments, overheard user comments, and notifications. The host comment queue may include comments received by the hosts of the event. The contents of the host comment queue may be provided to the queue for each user device signed up for the event and to the comment database 970. The user comment queue may include comments received from audience member user devices. The contents of the user comment queue may be provided to the backend module 960 for analysis of individual comments.

The backend module 960 may include computer software configured to analyze individual comments. The backend module 960 may score individual comments based on the user's Volume and comment ratings. The backend module 960 may determine whether individual comments are overheard within an event based on the score. The backend module may provide any overheard comments to the queue for each user device signed up for the event. The backend module may also provide the comment and score to the comment database 970.

The comment database 970 may include a machine readable storage medium configured to store information regarding comments. In various embodiments, the comment database 970 may include a cache of active comments. The cache may be distributed across multiple servers or server instances, allowing for greater scalability of the social network platform. The comment database 970 may include a tuple for each comment. The tuple may include information such as the comment content, timestamp, score, comment type, and flags. The comment type may include host comments, user comments, moderator comments, and host spotlight comments. Host comments may be comments made by a host of the event. User comments may be comments made by audience members of the event. Overheard comments may be user comments that have an overheard flag set. Moderator comments may be comments made by a moderator for the social network platform. Host spotlight comments may be comments made by an audience member that have been spotlighted by a host. Host spotlight comments may be a separate entry in the comment database 970 linked to the original user comment.

According to various embodiments, the user devices 910 and/or server 920 may additionally enable unpublished text messaging between users with the option for later publication. In particular, sometime after beginning an unpublished conversation with a remote user, a local user may select an option to publish the conversation or selected entries therefrom. Thereafter, the conversation or selected entries are made available to the other users of the social network platform as an active conversation or as an ended conversation in accordance with the methods and systems described above. Various modifications will be apparent in view of the following.

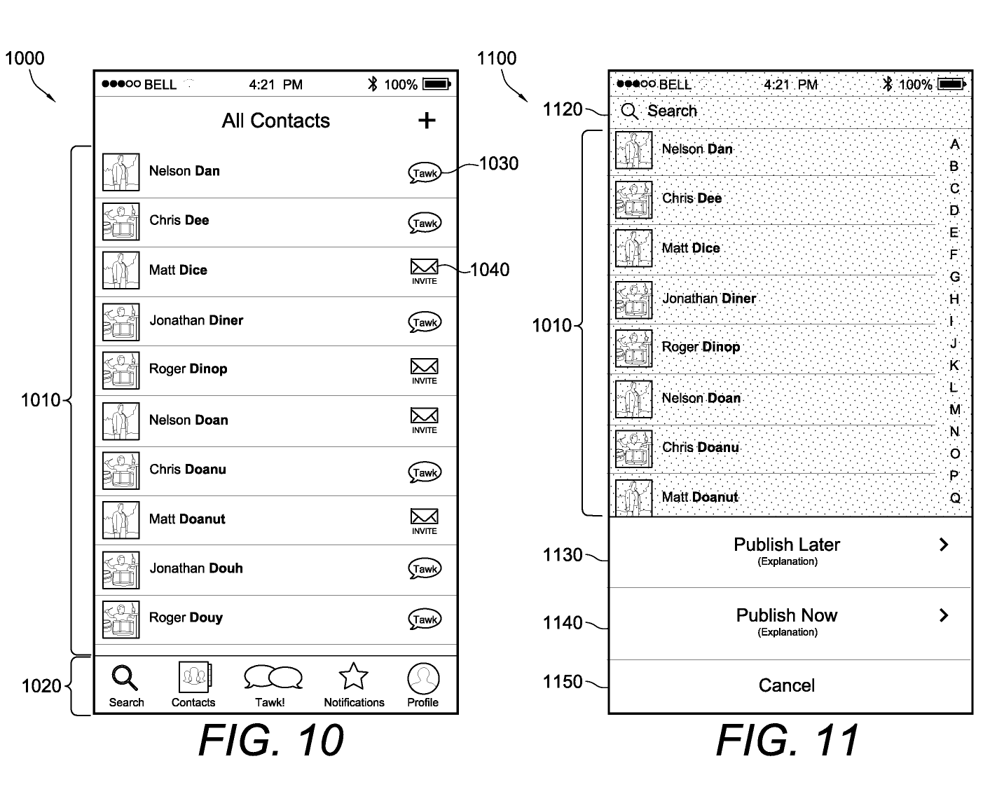

FIG. 10 illustrates an exemplary user interface 1000 for presenting a contact list. As shown, the interface 1000 (as well as the interfaces shown in FIGS. 11-15) is an interface for a mobile device, tablet, or other user device having a touch-screen display. Various modifications for presenting similar user interfaces via other user devices, such as desktop or laptop computers, will be apparent.

The user interface 1000 includes a contact list 1010 and a set of navigation buttons 1020. The navigation buttons 1020 enable the user to select different interfaces for display including a search interface, a contact list interface, an existing conversations interface, a notifications interface, and a user profile interface. Alternative or additional buttons and corresponding interfaces will be apparent. As shown, the set of navigation buttons 1020 indicates that the contact list interface is currently displayed.

The contact list 1010 displays a listing of remote users with which a conversation may be initiated. In various embodiments, the contact list 1010 may be populated from multiple sources. For example, the contact list 1010 may include contacts known to the user via the social networking platform (e.g. “followers”) and contacts stored in the user device that may be contacted via other communication channels (e.g. “phone contacts”). Such other contacts may include contacts that may be contacted via a phone number, email address, assigned user name in another service such as a different social network, or virtually any other channel. In some embodiments, including the illustrated embodiment, the contact list 1010 includes an indication or other visual distinction of to which group a contact belongs. For example, a first indication 1030 may be used to indicate that the contact is known via the social networking platform and may be selected to initiate a new conversation. A second indication 1040 may be used to indicate that the contact is known through other channels and may be selected to send an invitation the contact to join the social networking platform by registering an account. Alternatively, the second indication 1040 may be selected to initiate a text messaging conversation or other communication channel outside of the social networking platform.

FIG. 11 illustrates an exemplary user interface 1100 for beginning a new conversation with a selected contact. This user interface 1100 is displayed after a user has selected a contact with which to begin a new conversation. As shown, the user interface 1100 includes a contact list 1110 and a search bar 1120 that may be used to search for specific contacts within the contact list 1110. Upon selecting a contact, three buttons 1130, 1140, 1150 are displayed on top of the contact list 1110. A first button 1130 is presented to allow the user to begin the new conversation as an unpublished conversation. Such unpublished conversation may be accessed by only the parties involved in the conversation. For example, only the two parties to a two-way conversation may access an unpublished conversation via the non-administrative front end of the social networking platform. In various embodiments, a published conversation may also be private and accessible only to select members of the public at large that are not parties to the conversation. For example, a published conversation may be password protected or accessible by invite only for reading and commenting on the conversation between the parties. Various modifications for unpublished conversations between more than two-parties will be apparent.

The second button 1140 is presented to allow the user to begin the new conversation as a published conversation. Such a published conversation may be accessible to both the parties to the conversation and the users-at-large of the social networking platform, as is described in detail above with respect to FIGS. 1-9. As such, users that are not party to the conversation may view and comment on the published conversation. The third button 1150 presents the user an option to abort creation of the new conversation.

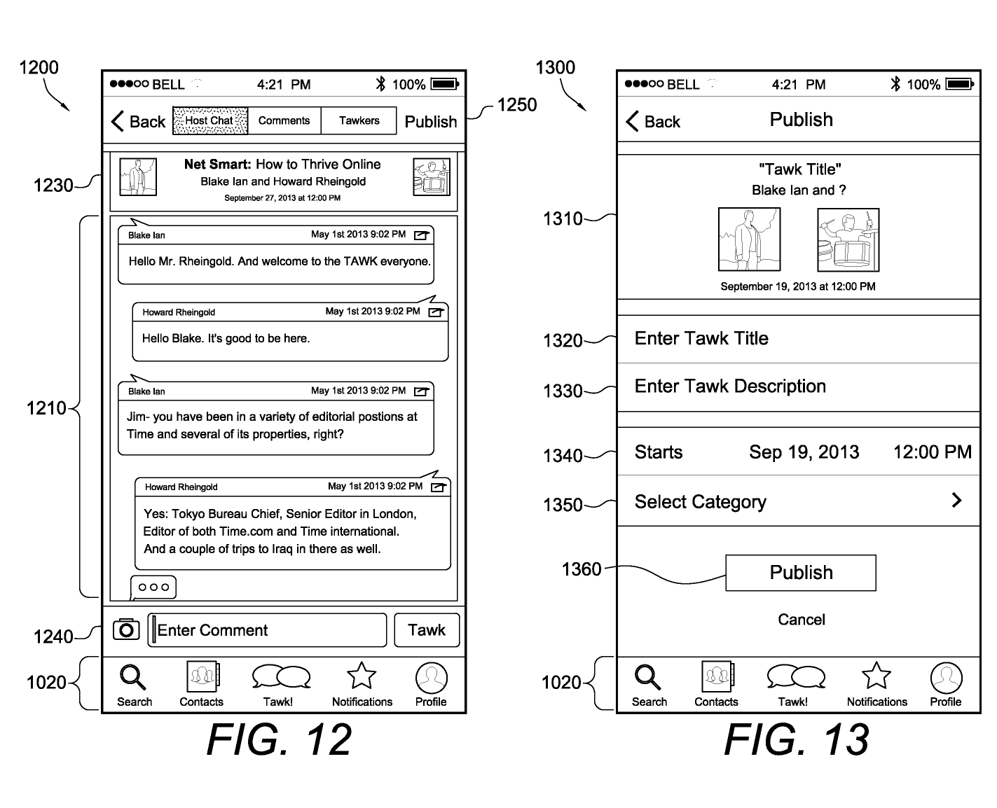

FIG. 12 illustrates an exemplary interface 1200 for presenting an unpublished conversation. The interface 1200 may be presented to the local user after beginning a new unpublished conversation. As shown, the interface 1200 includes a text message field 1210 showing the text messages exchanged between the parties in association with the unpublished text messaging conversation. The interface 1200 also presents a title block 1230 and an input block 1240. As shown, the title block includes a title for the conversation, parties to the conversation, and the start time of the conversation. In various embodiments, information such as a title and/or start time may not be assigned until publication; in such embodiments, the title block 1230 may show only one or more party names or other alternative information. The input block 1240 includes a text box for the local user to enter a text message and a send button to commit the entered text to the conversation.

The interface 1200 also includes a publish button 1250 for proceeding to publish the entire unpublished conversation up to the point the button 1250 is pressed or user-selected portions thereof. In various embodiments, the other parties to the conversation may be requested to confirm publication before the conversation is actually published. For example, remote user parties may be presented with a list of comments selected by the local user and given the option to approve, deny, or modify the list of comments to be published. In various embodiments, this requirement for party consent may be automatic or may be based on a user profile option that requests consent be obtained before publication.

As will be apparent, the software segments for conducting published conversations may be reused for conducting unpublished conversations. For example, in some embodiments, the same user interface 1200 may be used for conducting conversations that have already been published. As such, the interface 1200 may also provide the local user the option to view public user comments or a list of public users currently viewing the conversation. In such a scenario, the publish button 1250 may be removed, grayed out, or otherwise deactivated. Various modifications will be apparent.

FIG. 13 illustrates an exemplary interface 1300 for publishing a conversation. This interface 1300 may be presented to the user upon a decision to publish a conversation. For example, the interface 1300 may be displayed after a user selects the published new conversation button 1140 or the publish existing conversation button 1250. The interface 1300 includes a summary block 1310, a title entry block 1320, a conversation description entry block 1330, a start time entry block 1340, a category selection block 1350, and a publish button 1360. The local user uses the interface 1300 to enter conversation information metadata used to describe and categorize the conversation prior to publication. In some embodiments, the start time block 1340 may be automatically set based on the current time or another known time, such as when an unpublished text messaging to be published was initiated. Upon selecting the publish button 1360, the user device sends a publication request to the social networking platform server.

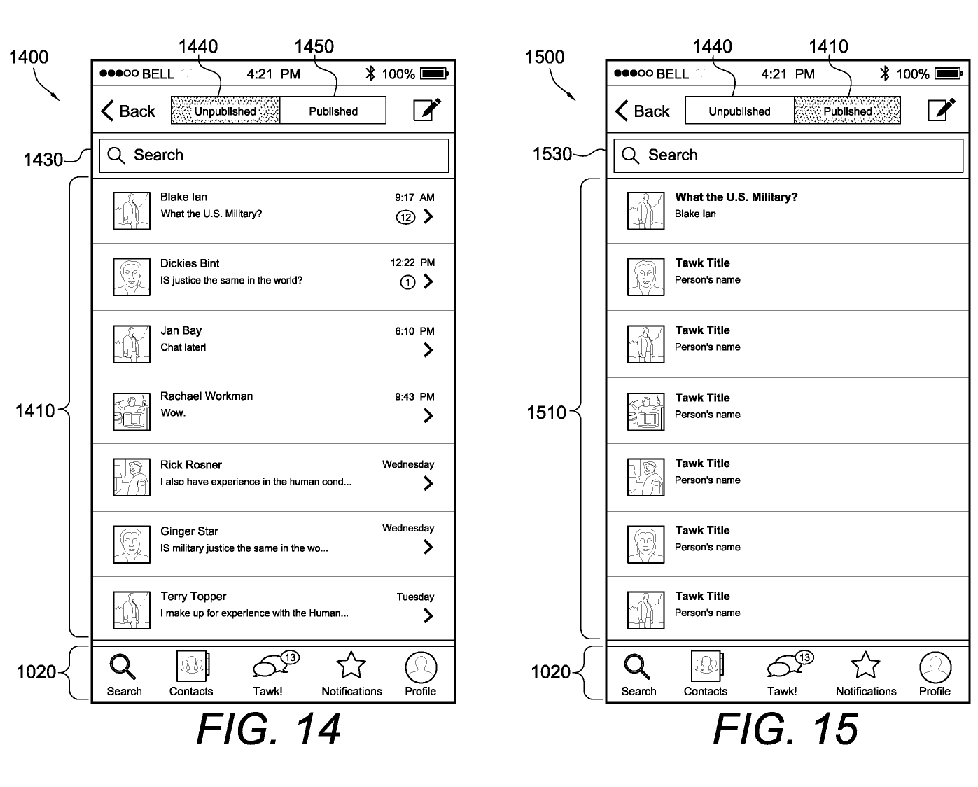

FIG. 14 illustrates an exemplary interface 1400 for presenting a list of unpublished conversations. As shown, the interface 1400 includes a list of conversations 1410 with remote users. After beginning and leaving a text messaging conversation, the local user may return to the conversation by selecting it from the list 1410. The user interface 1400 also includes a search bar 1430 for searching through the list of unpublished conversations 1410.

At the top of the interface 1400, two buttons 1440, 1450 are presented to toggle between a list of unpublished and a list of published conversations. FIG. 15 illustrates an exemplary interface 1500 for presenting a list of published conversations. The interface 1500 includes a list of published conversations 1510 along with a search bar 1530 for searching through the list 1510. The local user may return to a previously-initiated published conversation by selecting an entry in the list 1510. This interface 1500 may be accessible by the user selecting the published conversations button 1450. Similarly, the user may return to the unpublished conversations list interface 1400 by selecting the unpublished conversations button 1440.

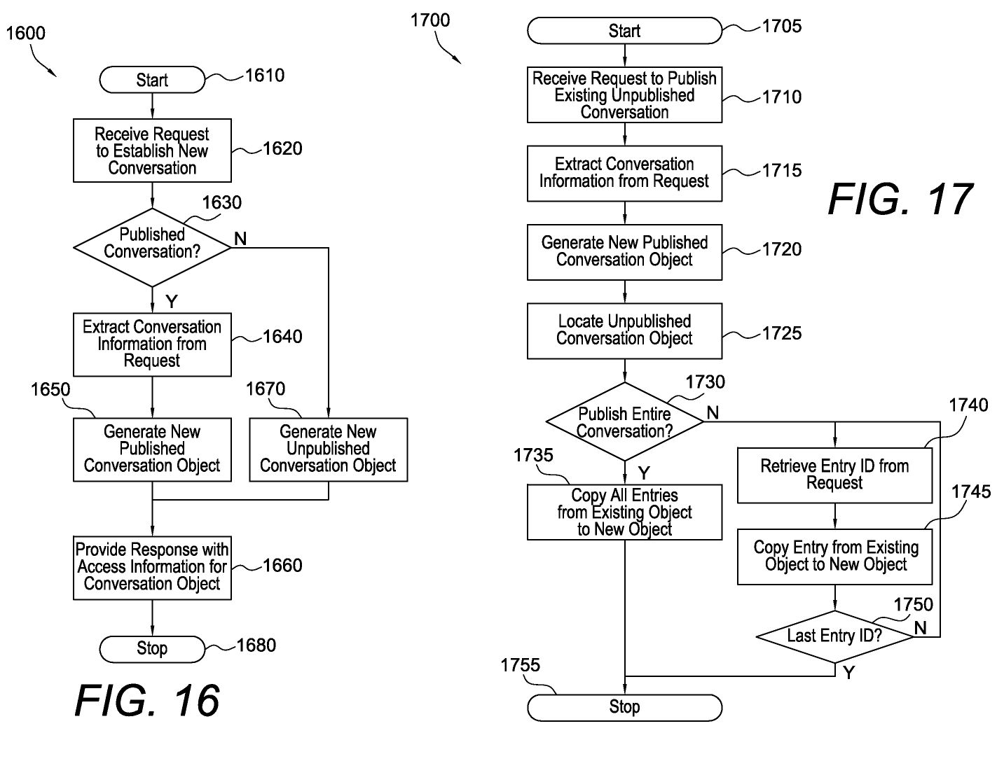

FIG. 16 illustrates an exemplary method 1600 for establishing a new conversation. This method may be performed by a server of the social networking platform, such as the server 920 illustrated in FIG. 9.

The method 1600 may begin in step 1610 and proceed to step 1620 where the server receives a request to establish a new conversation. Next, in step 1630, the server determines whether the request is for a published or unpublished conversation. If the request is for a published conversation, the method 1600 proceeds to step 1640 where the server extracts conversation metadata such as a title, description, start time, and/or category from the request. Next, in step 1650, the server generates a new published conversation object using the metadata and proceeds to provide a response to the requestor with information sufficient to access the new conversation object as a party to the conversation. For example, the server may send a URL or identifier string for the new conversation object. The method then proceeds to end in step 1680.

If, on the other hand, the server determines that the request is for an unpublished conversation, the method 1600 proceeds from step 1630 to step 1670 where the server generates a new unpublished conversation object to represent the new conversation. The method then proceeds to step 1660 and end in step 1680.

Various modifications to this method 1600 and the other methods described herein with respect to FIGS. 17-19 will be apparent. For example, in various embodiments, the server may not maintain any record or other object representing unpublished conversations; instead, unpublished conversations may be established in a peer-to-peer manner. In such embodiments, steps 1630 and 1670 may be omitted from the method 1600 for generating new conversations. As another example, some embodiments may not include all the information used in creating a new object in the initial request. For example, in some embodiments, such as those implementing a web-based interface, multiple message exchanges between the client and server may be utilized to retrieve the information used to create the object. As yet another example, in some embodiments various metadata may also be used to establish a new unpublished conversation object; in such embodiments, a step similar to step 1640 may precede step 1670. Various additional modifications will be apparent.

As noted, in various embodiments, a user may be able to select an existing unpublished conversation, or portions thereof, for publication. FIG. 17 illustrates an exemplary method 1700 for publishing a previously-created conversation. This method may be performed by a server of the social networking platform, such as the server 920 illustrated in FIG. 9.

The method 1700 begins in step 1705 and proceeds to step 1710 where the server receives a request to publish an existing unpublished conversation. For example, such a request may be generated and sent by a user device in response to the user selecting a publish button such as the publish button 1250 of the conversation interface 1200 or the publish button 1360 of the publish interface 1300. Next, in step 1715, the server extracts conversation information metadata such as a title, description, start time, and/or category from the request. Such information may be entered via the publish interface 1300. Next, in step 1720, the server generates a new published conversation object and, in step 1725, locates the existing unpublished conversation object associated with the conversation to be published. In step 1730, the server determines whether the request message requests that the entire conversation be published. If so, the server simply copies all text message entries from the unpublished object to the new published object. Otherwise, the server retrieves a first text message entry identifier from the request in step 1740 and copies the corresponding entry from the unpublished object to the new published object in step 1745. In step 1750, the server determines whether the request includes additional entry identifiers. If so, the method 1700 loops back to step 1740. Otherwise, the method proceeds to end in step 1755.

Various modifications will be apparent. For example, in some embodiments, only a single type of conversation object may be utilized to represent both published and unpublished conversations. In such embodiments, instead of creating a new published conversation object, the server may create the published conversation object by converting the existing object to a published conversation object by, for example, setting an overall “published” Boolean value to true or by setting individual “published” Booleans associated with selected individual text message entries to “True.” In other embodiments, the new published conversation may continue as a live conversation for further entry of text messages and comments; in such embodiments, the server may proceed to provide the parties with access to the published conversation in a manner similar to step 1660 of method 1600.

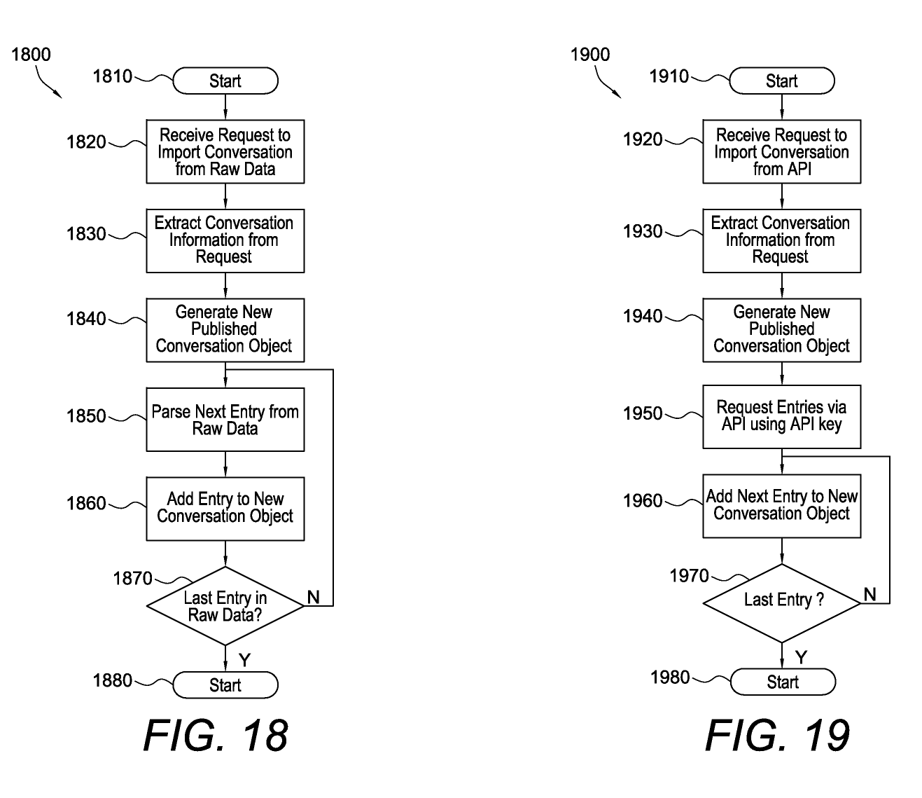

In various embodiments, existing unpublished conversations from external services may be published on the social networking platform. For example, SMS text messages conversation, instant messaging conversations, chat conversations, and conversations on other social networks may be imported into the social networking platform. It will be understood that some such conversations may be available to the public via the other services; however, from the perspective of the social network platform, such conversations are unpublished because they are unavailable to non-parties of the conversation via the social networking platform. FIG. 18 illustrates an exemplary method 1800 for importing a conversation using raw data. This method may be performed by a server of the social networking platform, such as the server 920 illustrated in FIG. 9.

The method 1800 begins in step 1810 and proceeds to step 1820 where the server receives a request to import a conversation from raw data. The user device may upload such raw data manually by a user “copying and pasting” the contents of a text message into a text field of the client interface. Additionally or alternatively, various other services may include features for exporting conversations as raw data (which may include various formatting or annotations); such exported data may be directly uploaded to the social networking platform server in response to a user request, either within the client interface for the social networking platform or within the external service application.

Next, in step 1830, the server extracts conversation information metadata such as a title, description, start time, and/or category from the request. Such metadata may be entered by the user and/or read from the raw data. Then, in step 1840, the server generates a new published conversation object. The server parses the raw data carried by the request in step 1850 (and may rely at least partially on formatting or annotations carried in the raw data) to generate individual text message entries, which are then stored in the conversation object in step 1860. The server iterates through the entries in the raw data until the server determines in step 1870 that no more entries exist for parsing. The method then ends in step 1880.

According to another method for importing external text messaging conversations, the server interacts with an application programming interface (API) of an external service to retrieve messages defining the conversation. FIG. 19 illustrates an exemplary method 1900 for importing a conversation via an external server API. This method may be performed by a server of the social networking platform, such as the server 920 illustrated in FIG. 9.

The method 1900 begins in step 1910 and proceeds to step 1920 where the server receives a request to import a conversation from via an external service API. The user device or external service may send such a request in response to a user selecting an option provided by the external service to export a conversation to the social networking platform or based on the user selecting an option provided by the interface of the social networking platform to import a conversation from a known external service.

Next, in step 1930, the server extracts conversation information metadata such as a title, description, start time, and/or category from the request. Such metadata may be entered by the user. Additionally or alternatively, the server may obtain metadata from the external service via the API, the operation of which will be described below. Then, in step 1940, the server generates a new published conversation object. The server retrieves text messages associated with the conversation from the external service via the API in step 1950, which are then stored in the conversation object in step 1960. In various embodiments, the server may utilize various API keys to present authorized requests for the conversation data. For example, the server may present a permission key associated with the requesting user received as part of the request in step 1920. The server iterates through the retrieved entries from the API until the server determines in step 1970 that no more entries exist for parsing. The method then ends in step 1980.

It will be noted that, while the import methods 1800, 1900 describe importing conversations as published conversations, various embodiments may import conversations as unpublished or may give the user an option as to whether the imported conversation will be published or unpublished. When an unpublished conversation is imported, the user may subsequently be able to publish the entire conversation or portions thereof.

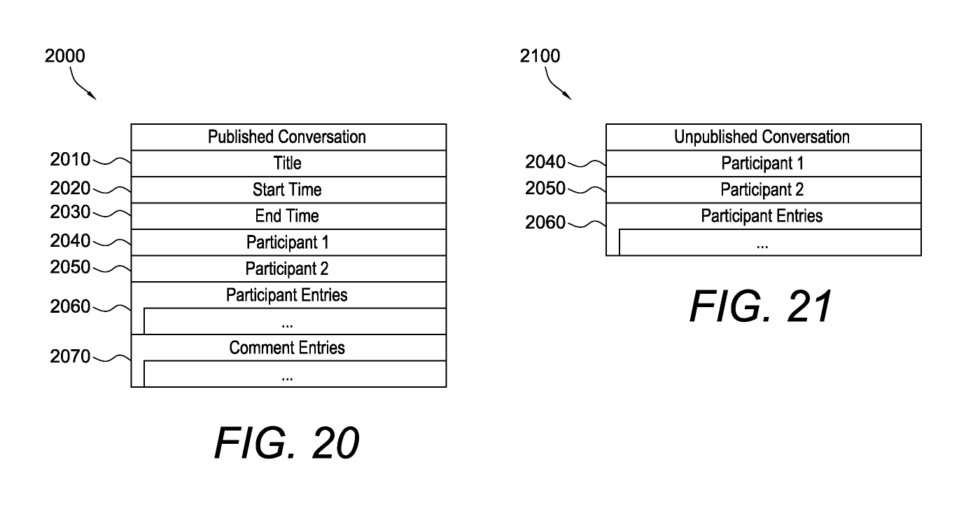

FIG. 20 illustrates an exemplary data arrangement 2000 for storing a published conversation. The data arrangement 2000 may be stored as virtually any object including, but not limited to, records, table entries, linked lists, trees, and/or virtually any other data structures. As shown, the data arrangement 2000 is provided with space to store a title 2010, a start time for the conversation 2020, an end time 2030, and the identities of the participants in the conversation 2040, 2050. In various embodiments, the existence of value in the end time field 2030 may be used to determine whether the conversation is live or ended.

The data arrangement 2000 also identifies multiple participant entries 2060 related to individual text messages. For example, the participant entries field 2060 may store the data representing text messages themselves or identifiers that may be used to retrieve separate text message objects from a different area of storage. Similarly, a comment entries field 2070 may store identifications (e.g. data or identifiers) of comment messages left by non-participant users in association with the conversation.

FIG. 21 illustrates an exemplary data arrangement 2100 for storing an unpublished conversation. The data arrangement 2100 may be stored as virtually any object including, but not limited to, records, table entries, linked lists, trees, and/or virtually any other data structures. As shown, the data arrangement 2100 includes similar fields to the data arrangement 2000, including participant fields 2040, 2050 and a participant entries field 2060. Because the data arrangement 2100 represents an unpublished conversation, the data arrangement 2100 may not include various information such as, for example, a title, start time, end time, or any comment entries. In various embodiments, the two data arrangements 2000, 2100 may be the same as each other. For example various fields 2010, 2020, 2030, 2070 may be present but empty in the unpublished data arrangement 2100. In such embodiments, the server may differentiate between published and unpublished objects on the basis of whether such fields are provided with data or on the basis of one or more additional fields for indicating whether the object or individual entries are published.

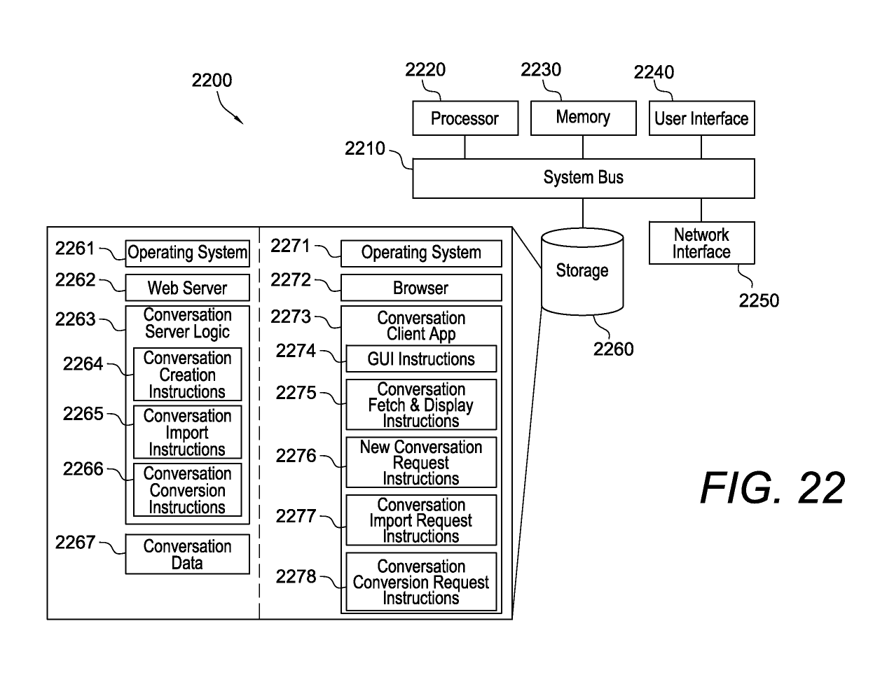

FIG. 22 illustrates exemplary hardware 2200 for implementing a user device or a server. As shown, the device 2200 includes a processor 2220, memory 2230, user interface 2240, network interface 2250, and storage 2260 interconnected via one or more system buses 2210. It will be understood that FIG. 22 constitutes, in some respects, an abstraction and that the actual organization of the components of the host device 2200 may be more complex than illustrated.

The processor 2220 may be any hardware device capable of executing instructions stored in memory 2230 or storage 2260 or otherwise processing data. As such, the processor may include a microprocessor, field programmable gate array (FPGA), application-specific integrated circuit (ASIC), or other similar devices.

The memory 2230 may include various memories such as, for example L1, L2, or L3 cache or system memory. As such, the memory 2230 may include static random access memory (SRAM), dynamic RAM (DRAM), flash memory, read only memory (ROM), or other similar memory devices.

The user interface 2240 may include one or more devices for enabling communication with a user such as an administrator. For example, the user interface 2240 may include a display, a mouse, and a keyboard for receiving user commands. In some embodiments, the user interface 2240 may include a command line interface or graphical user interface that may be presented to a remote terminal via the network interface 2250.

The network interface 2250 may include one or more devices for enabling communication with other hardware devices. For example, the network interface 2250 may include a network interface card (NIC) configured to communicate according to the Ethernet protocol. Additionally, the network interface 2250 may implement a TCP/IP stack for communication according to the TCP/IP protocols. Various alternative or additional hardware or configurations for the network interface 2250 will be apparent.

The storage 2260 may include one or more machine-readable storage media such as read-only memory (ROM), random-access memory (RAM), magnetic disk storage media, optical storage media, flash-memory devices, or similar storage media. For example, where the hardware 2200 implements a social networking platform server, the storage may store operating system instructions 2261 and web server instructions 2262. The storage 2260 may also store conversation server logic instructions 2263 for serving as a backed to the web server 2262. The conversation server logic instructions 2263 may include various subsets of instructions include instructions for creating new conversations 2264, instructions for importing conversations from external sources 2265, and instructions for converting unpublished conversations to published conversations 2266. The storage 2260 is also shown to store conversation data 2267 such as various published and unpublished conversation objects.

Where the device 2200 implements a client device, the storage 2260 stores an operating system 2271, web browser 2272, and a conversation client application 2273 which may make use of the browser 2272 to communicate with a server. The conversation client application instructions 2273 may include multiple subsets of instructions such as instructions for presenting a graphical user interface (GUI) 2274, instructions for fetching and displaying a conversation from a server 2275, instructions for sending a request for a new conversation to the server 2276, instructions for requesting that a conversation from an external service be imported 2277, and instructions for requesting publication of an unpublished conversation 2278.

It will be apparent that various information described as stored in the storage 2260 may be additionally or alternatively stored in the memory 2230. For example, portions of the operating system 2261, 2271 may be resident in the memory 2230 for quick access. In this respect, the memory 2230 may also be considered to constitute a “storage device” and the storage 2260 may be considered a “memory.” Various other arrangements will be apparent. Further, the memory 2230 and storage 2260 may both be considered to be “non-transitory machine-readable media.” As used herein, the term “non-transitory” will be understood to exclude transitory signals but to include all forms of storage, including both volatile and non-volatile memories.

While the device 2200 is shown as including one of each described component, the various components may be duplicated in various embodiments. For example, the processor 2220 may include multiple microprocessors that are configured to independently execute the methods described herein or are configured to perform steps or subroutines of the methods described herein such that the multiple processors cooperate to achieve the functionality described herein. Further, in some embodiments, such as embodiments wherein the device 2200 is implemented in a cloud computing environment, the hardware may be distributed among multiple physical devices which may be geographically distributed among multiple data centers. For example, the device 2200 may include a first processor located in a first data center and a second processor located in a second data center.

According to the foregoing, various exemplary embodiments provide for a social networking platform. In particular, by providing hosted events with a rating system for comments, the social networking platform may provide an effective platform for meaningful dialogue between participants. Further, by providing the option to publish existing but unpublished text messaging conversations, users are able to integrate conversations into the social networking platform. Various additional benefits will be apparent in view of the foregoing.

It should be apparent from the foregoing description that various exemplary embodiments of the invention may be implemented in hardware, and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention.

We claim:

1. A non-transitory machine-readable storage medium encoded with instructions for execution by a user device, the non-transitory machine-readable storage medium comprising:
instructions for establishing a new text messaging conversation between a local user and a remote user, wherein the new text messaging conversation is initially an unpublished conversation that is accessible to only the local user and the remote user;
instructions for enabling continued communication between the local user and the remote user via the text messaging conversation;
instructions for receiving, from the local user, a command to publish the text messaging conversation;
instructions for, in response to receiving the command to publish the text messaging conversation, transmitting a publish request to publish at least a portion of the text messaging conversation to a social networking server that provides additional users access to published conversations.

2. The non-transitory machine-readable storage medium of claim 1, wherein the instructions for establishing, enabling, receiving, and transmitting are part of a single application, the non-transitory machine-readable storage medium further comprising:
instructions for presenting a contact list to the local user, wherein the contact list includes both social network contacts that are associated with the social networking server and external contacts that are associated with a communication channel other than the social networking server; and instructions for presenting a visual distinction between the social network contacts and the external contacts.

3. The non-transitory machine-readable storage medium of claim 1, wherein:
the instructions for establishing and the instructions for enabling are part of a first application,
the instructions for receiving and the instructions for transmitting are part of a second application that is different from the first application, and
the publish request comprises an import request to import the text messaging conversation to the social networking server from an external service associated with the first application.

4. The non-transitory machine-readable storage medium of claim 3, wherein the publish message includes data representing a plurality of text messages from the text messaging conversation.

5. The non-transitory machine-readable storage medium of claim 3, wherein the publish message identifies an external service that implements an application programming interface (API) configured to provide the social networking server with data representing a plurality of text messages from the text messaging conversation.

6. The non-transitory machine-readable storage medium of claim 1, further comprising:
instructions for displaying a plurality of comments from the additional users in association with the text messaging conversation.

7. A non-transitory machine-readable storage medium encoded with instructions for execution by a social networking server, the non-transitory machine-readable storage medium comprising:
instructions for receiving, from a user device, a publish request to publish at least a portion of an unpublished text messaging conversation between a first user and a second user;
instructions for creating a published conversation object in response to receiving the publish request, wherein the published conversation object identifies a plurality of text messages between the first user and the second user from the at least a portion of the text messaging conversation; and
instructions for serving data representing the plurality of text messages to a plurality of additional users based on the published conversation object.

8. The non-transitory machine-readable storage medium of claim 7, further comprising:
instructions for receiving a plurality of comment messages regarding the plurality of text messages from the additional users;
instructions for adding, to the published conversation object, identifications of the plurality of comment messages; and
instructions for serving data representing the plurality of comment messages to the plurality of additional users in association with the data representing the plurality of text messages.

9. The non-transitory machine-readable storage medium of claim 7, further comprising:
instructions for copying identifications of the plurality of text messages from a previously-created unpublished conversation object associated with the text messaging conversation to the published conversation object.

10. The non-transitory machine-readable storage medium of claim 7, wherein the instructions for creating a published conversation object comprise:
instructions for locating a previously-created unpublished conversation object associated with the text messaging conversation; and
instructions for setting a value of the unpublished conversation object to indicate publication of the at least a portion of the unpublished text messaging conversation to convert the unpublished conversation object into the published conversation object.

11. The non-transitory machine-readable storage medium of claim 7, wherein the instructions for creating a published conversation object comprise instructions for retrieving the plurality of text messages from the publish request.

12. The non-transitory machine-readable storage medium of claim 11, wherein the instructions for retrieving the plurality of text messages from the publish request comprise instructions for parsing the plurality of text messages from raw data carried by the publish request.

13. The non-transitory machine-readable storage medium of claim 7, wherein the instructions for creating a published conversation object comprise instructions for retrieving the plurality of text messages from an external server associated with an external service via an application programming interface (API).

14. A social networking server comprising:
a network interface in communication with a plurality of user devices;
a storage device configured to store a plurality of published conversation objects; and
a processor in communication with the network interface and the storage device, the processor being configured to:
receive, via the network interface from a first user device of the plurality of user devices, a publish request to publish at least a portion of an unpublished text messaging conversation between a first user and a second user,
create a published conversation object for storage in the storage device in response to receiving the publish request, wherein the published conversation object identifies a plurality of text messages between the first user and the second user from the at least a portion of the text messaging conversation, and
serve data representing the plurality of text messages to a plurality of additional users based on the published conversation object.

15. The social networking server of claim 14, wherein the processor is further configured to:
receive a plurality of comment messages regarding the plurality of text messages from the additional users;
add, to the published conversation object, identifications of the plurality of comment messages; and
serve data representing the plurality of comment messages to the plurality of additional users in association with the data representing the plurality of text messages.

16. The social networking server of claim 14 wherein the processor is further configured to:
copy identifications of the plurality of text messages from a previously-created unpublished conversation object associated with the text messaging conversation to the published conversation object.

17. The social networking server of claim 14 wherein, in creating a published conversation object, the processor is configured to:
locate, within the storage device, a previously-created unpublished conversation object associated with the text messaging conversation; and
set a value of the unpublished conversation object to indicate publication of the at least a portion of the unpublished text messaging conversation to convert the unpublished conversation object into the published conversation object.

18. The social networking server of claim 18 wherein, in creating a published conversation object, the processor is configured to retrieve the plurality of text messages from the publish request.

19. The social networking server of claim 18 wherein, in retrieving the plurality of text messages from the publish request, the processor is configured to parse the plurality of text messages from raw data carried by the publish request.

20. The social networking server of claim 14 wherein, in creating a published conversation object, the processor is configured to retrieve the plurality of text messages from an external server associated with an external service via an application programming interface (API).
